(19) United States
(12) Patent Application Publication
(10) Pub. No.: US 2006/0227850 A1
(43) Pub. Date: Oct. 12, 2006

(54) Slip on bath water thermometer

(76) Inventor: Clifton Ross Johnson, Fort Calhoun, NE (US)

Correspondence Address: Clifton R. Johnson, P.O. Box 108, Blair, NE, 68008, US

(21) Appl. No.: 11/399,656

(22) Filed: Apr. 6, 2006

Related U.S. Application Data
(60) Provisional application No. 60/668,553, filed on Apr. 6, 2005.

(51) Int. Cl. G01K 1/00

(52) U.S. Cl. 374/208; 374/147

(57) ABSTRACT

This slip on bath water thermometer allows any user to almost instantly know the temperature of the water entering the bath or vessel to accuracy of 1/10^{th} of one degree Fahrenheit or Celsius. It is a flexible slide on extension which has a fast read digital thermometer attached by being screwed into the flexible part with a thermometer probe inserting into the center of the water flow cavity of the flexible part. Installation of the slide on invention requires no tools and no removal or changes to existing faucet parts, and enabling most anyone to use for a safe and comfortable bath.

### CROSS REFERENCE TO RELATED APPLICATIONS

This non provisional utility application cross references provisional application No. 60/668,553 filed Apr. 5, 2005.

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISK APPENDIX

Not applicable

### BACKGROUND OF THE INVENTION

To allow a parent, the elderly or anyone a truly simple way to fill a safe and comfortable bath to the accuracy of 1/10^{th} of 1 degree Fahrenheit or Celsius, allowing the small envelope of degrees of safe bath temperature to be attained. The need for, and lack of a prior simple slip on device that anyone can easily use requiring no tools and no changing of faucet parts, to allow the user to see very quickly the temperature of the water exiting from a bath faucet within 1/10^{th} of a degree Fahrenheit or Celsius.

### BRIEF SUMMARY OF THE INVENTION

A slide on, flexible, bath faucet extension with a in line fast read digital thermometer allowing a mom, the elderly, or any user to fill a safe and comfortable bath by simply slipping onto a bath faucet and adjusting the hot and cold water handles to attain the preferred temperature of water exiting faucet by viewing digital thermometer, requiring no tools or removal or changing of any faucet parts.

### BRIEF DESCRIPTION OF THE SEVERAL VIEWS OF THE DRAWING

FIG. 1 slip on flexible device with digital thermometer, attached by threading the ¼″×⅛″-27 tapered pipe threaded collar into the matching female threads in the flexible part.

FIG. 2 thermometer sensor probe shown attached to part in center of water flow chamber.

FIG. 3 face of thermometer

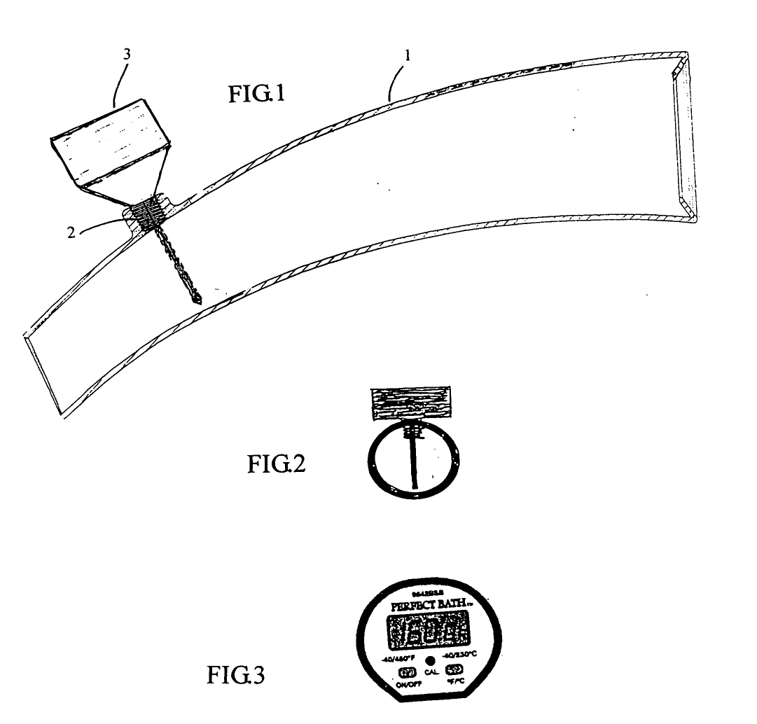

### DETAILED DESCRIPTION OF THE INVENTION

This new slip on bath temperature thermometer invention consists of three parts, The flexible slip on part 1, the male threaded ¼″×⅛″-27 tapered pipe thread collar permanently bonded around the thermometer probe 2, and the fast read digital thermometer 3.

The flexible part may be made of most any flexible material which can be injection molded by manufacturer. It can be made most any color. There is a machined threaded collar with male threads permanently bonded to, and that surrounds the conventional digital thermometer probe, which allows for the attachment or removal of The thermometer with the female threads molded in the top front center of the flexible part, inserting the thermometer sensor probe into the water flow cavity. The thermometer Has a replaceable battery, an on/off switch and a switch for Fahrenheit or Celsius readings.

The flexible slip on part may be simply slipped on to most bath faucets by anyone, using no tools, then the user may easily and quickly view the fast read thermometer to know the water temperature entering the batch or vessel within 1/10^{th} of one degree Fahrenheit or Celsius.

1. I claim . . . a new slip on fast read digital thermometer device which has a flexible part that simply slips on to most bath faucets using no tools and requires no removal or changing of any faucet parts, and said flexible part has attached to it by way of designed and machined male threaded collar, designed for such attachments, a fast read digital thermometer that reads to 1/10^{th} of one degree Fahrenheit or Celsius by screwing into female threads in flexible part, allowing the thermometer sensor probe to be inserted into the water flow cavity of the flexible part, further, allowing the user to almost instantly and accurately within 1/10^{th} of one degree Fahrenheit or Celsius, know the temperature of the water flowing from the faucet and entering the bath or vessel allowing for a safe and desired bath temperature to be attained.
